(19) United States
(12) Patent Application Publication
(10) Pub. No.: US 2004/0123501 A1
(43) Pub. Date: Jul. 1, 2004

(54) Dynamic messaging sign

(75) Inventors: Ramin Safavi, Toronto (CA); Raymond Siu Ming Poon, Mississauga (CA); Vladimir A. Volochine, Toronto (CA); Coeman Lam Sang Wong, Toronto (CA)

Correspondence Address: D. PETER HOCHBERG CO. L.P.A., 1940 EAST 6TH STREET, CLEVELAND, OH, 44114, US

(73) Assignee: Mark IV Industries Ltd.

(21) Appl. No.: 10/643,342

(22) Filed: Aug. 19, 2003

Related U.S. Application Data
(60) Provisional application No. 60/437,029, filed on Dec. 31, 2002.

(30) Foreign Application Priority Data
Jul. 16, 2003 (CA) 2,435,353

(51) Int. Cl. G09F 3/04

(52) U.S. Cl. 40/452

(57) ABSTRACT

A dynamic messaging sign that includes a plurality of display panels arranged side by side. Each of the display panels include a rigid front panel having an array of aperture holes formed therethrough, and a plurality of pixel modules arranged rearward of the front panel in alignment with the aperture holes for selectively generating indicators visible though the aperture holes. A sheet lens may be located between the planar central portion of the front panel and the pixel modules, extending over the aperture holes.

This application claims priority to U.S. provisional patent application serial No. 60/437,029 filed Dec. 31, 2002, which is incorporated herein by reference. This application also claims priority to Canadian Patent Application No. (unknown), filed Jul. 16, 2003.

### BACKGROUND OF THE INVENTION

This invention is directed towards dynamic messaging signs, and in particular to signs that are used to display messages large enough to be viewed from a substantial distance.

The use of large electronically controlled signs to display changing or dynamic messages is expanding, particularly in the highway environment where there is a growing need to provide motorists with current information in an attempt to reduce traffic congestion. Such signs typically include an enclosure having a forward facing display surface that includes an array of pixel display elements that can be selectively activated to collectively generate a visual message that can be viewed by motorists or others from the front of the sign. The enclosure will typically house the electronic components required for operation of the sign, and may include an internal work space that is accessible by a door or hatch. Depending on the climate where the sign is located, the sign may have internal cooling and/or heating systems. The size and complexity of large dynamic messaging signs make such signs expensive to manufacture, and the location of the signs, for example, mounted over or beside busy highways, can make them difficult to maintain.

In one common sign configuration, the display surface includes one or more large transparent or semi-transparent polycarbonate sheet lenses that are supported by a frame in a front opening of the enclosure. Metal panels, typically painted black on their forward facing sides, are located behind the lenses, and pixel display elements are aligned with holes provided through the metal panels. Such a configuration often requires the use of large polycarbonate sheets, which can be expensive and difficult to transport and install, and which require an intricate framing system to support. Maintenance of signs employing such a configuration can also be expensive and cumbersome.

Another common sign configuration makes use of lens frames that are hinged to the front of the enclosure. The frames each support a metal panel having an array of holes formed therethrough, with a polycarbonate lens located behind the metal panel. The lens frames are located in front of pixel display elements that are supported by the enclosure and which are located in alignment with respective holes through the metal panel when the lens frame is shut. Again, such a configuration can be expensive to build and maintain.

Thus, there is a need for a dynamic messaging sign that can be manufactured and maintained in a cost effective manner, and which can offer high reliability.

### SUMMARY OF THE INVENTION

According to one aspect of the invention, there is provided an informational display unit for a dynamic messaging sign, having at least two display panels that are arranged adjacent each other, each display panel including (i) a rigid front panel having a planar central portion with an array of aperture holes formed therethrough, (ii) a planar sheet lens through which light can pass secured behind the planar central portion, the sheet lens passing over the aperture holes, and (iii) a plurality of pixel display modules located behind the sheet lens, each pixel display module being aligned with one of the aperture holes for selectively displaying an indicator visible from a front of the display panels; the rigid front panels being joined along adjacent sides thereof and arranged with the front panel planar central portions substantially aligned in a common plane.

According to another aspect of the invention, there is provided a dynamic messaging sign having an enclosure having a forward facing opening and a plurality of display panels arranged side by side across the forward facing opening. Each of the display panels include (i) a rigid front panel having a substantially planar central portion with integral rearwardly extending peripheral sidewalls along opposite side edges thereof, the central portion having an array of aperture holes formed therethrough; and (ii) a plurality of pixel modules arranged rearward of the front panel in alignment with the aperture holes for selectively generating indicators visible though the aperture holes. The planar central portions are substantially aligned along a common plane with adjacent front panel sidewalls of adjacent display panels being secured together.

According to another embodiment of the invention, there is provided a dynamic messaging sign that includes an enclosure having a forward facing opening, a plurality of spaced apart, substantially parallel, elongate support columns connected to the enclosure and extending across the forward facing opening, and a plurality of display panels arranged side by side across the forward facing opening. Each of the display panels include a substantially planar rigid front panel having an array of aperture holes formed therethrough; and a plurality of pixel modules arranged rearward of the front panel in alignment with the aperture holes for selectively generating indicators visible though the aperture holes, the front panels being substantially aligned along a common plane, the support column being located between side-edges of the front panels of adjacent display panels.

According to yet another aspect of the invention, there is provided a dynamic messaging sign that includes (a) an enclosure having a forward facing opening; (b) a plurality of rigid front panels having an array of aperture holes therethrough, the front panels being arranged side-by-side across the forward facing opening; (c) a plurality of circuit boards mounted to the enclosure rearward of the front panels, the circuit boards having pixel modules arranged thereon in alignment with the aperture holes for selectively generating indicators visible through the apertures from a viewing direction forward of the sign, the circuit boards being spaced apart from the front panels to define air gaps therebetween; and (d) at least one fan located in the enclosure for directing air into the air gaps between the front panels and the circuit boards.

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

Example embodiments of the invention will be described with reference to the following Figures.

FIG. 1 is a front perspective view of a dynamic messaging sign according to embodiments of the present invention.

FIG. 2 is a sectional side view of the sign of FIG. 1.

FIG. 3 is a front view of a pixel module of the sign.

FIG. 4 is a partial elevational view of a front of the sign of FIG. 1, as viewed from an inside of an enclosure of the sign.

FIG. 5 is a front perspective view of two front panels of the sign of FIG. 1.

FIG. 6 is a sectional view, taken along the lines VI-VI of FIG. 4.

FIG. 7 is an enlarged portion of FIG. 4.

FIG. 8 is a partial elevational view of a front of the sign, as viewed from an inside of the enclosure of the sign, showing display panels according to another embodiment of the invention.

FIG. 9 is a partial sectional view, taken along the lines IX-IX, of FIG. 8.

FIG. 10 is a sectional side view of the sign of FIG. 8.

FIG. 11 is a sectional plan view of the sign of FIG. 8.

FIG. 12 is a sectional view of an alternative embodiment of the display panels of FIGS. 1 and 8.

FIG. 13 is a front perspective view of a dynamic messaging sign according to another embodiment of the invention.

FIG. 14 is a front perspective view of the enclosure of the dynamic messaging sign of FIG. 13.

FIG. 15 a partial horizontal sectional view of the dynamic messaging sign of FIG. 13.

FIG. 16 is a partial vertical sectional view of the dynamic messaging sign of FIG. 13.

FIG. 17 is an enlarged view of part of FIG. 13.

FIG. 18 is a side view of a clamp used in the sign of FIG. 13.

FIG. 19 is a partial sectional view, taken across the line XIX-XIX of FIG. 17.

FIG. 20 is a sectional side view of the sign of FIG. 13.

FIGS. 21A and 21B are enlarged views of part of FIG. 20, showing a front panel of a display unit in sliding and secured positions, respectively.

FIG. 22 is a front view of a front panel of the sign of FIG. 13.

FIG. 23 is a sectional side view of an alternative embodiment of the sign of FIG. 13.

FIG. 24 is an enlarged view of part of FIG. 23.

Like numbers are used throughout the description to refer to the same or similar elements.

### DETAILED DESCRIPTION

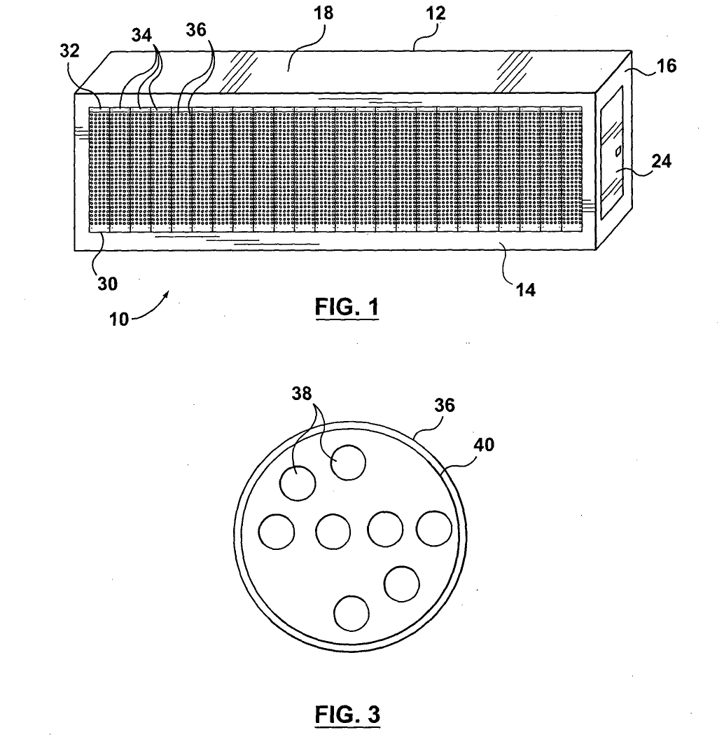

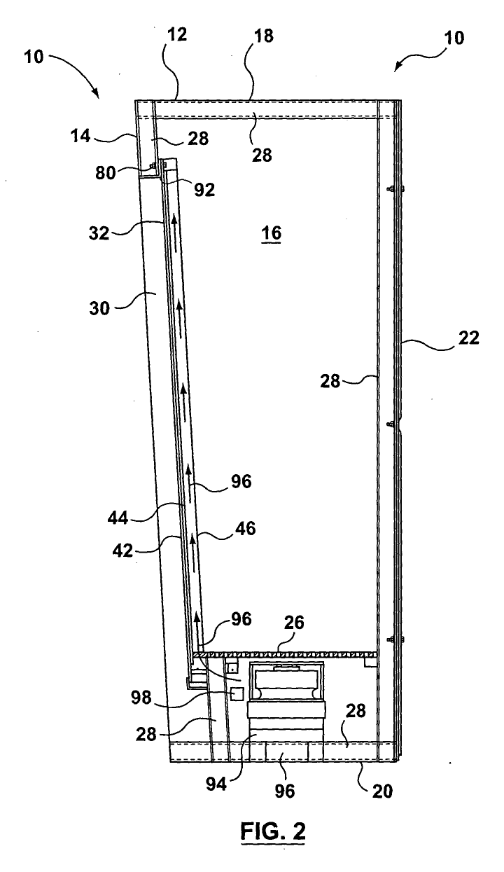

FIG. 1 shows a dynamic messaging sign indicated generally by reference numeral 10, according to embodiments of the present invention. The sign 10 includes a walk-in enclosure 12 that, as shown in FIGS. 1 and 2, has a front wall 14, side walls 16, a back wall 22, a top wall or roof 18, and a bottom 20. A door 24 may be located on one of the side walls 16 to provide access to the inside of the enclosure. Inside the enclosure there is a floor 26. The enclosure may include support beams 28 which provide a support frame for the walls, bottom and roof of the enclosure. Although sign 10 includes a walk-in style enclosure, other embodiments of the invention may include enclosures that are not walk-in enclosures.

A large rectangular opening 30 is provided within the front wall 14 in which is mounted an informational display unit 32. The display unit 32 is made up of a number of vertically elongated abutting modular display panels 34, including first and second end display panels and a plurality of intermediate display panels. Each display panel 34 includes an array of pixel modules 36. In the illustrated embodiment, each display panel 34 includes a 5 by 28 array of pixel modules 36, however, different array sizes can be used, and in some embodiments, different display panels 34 within the same sign can have different array sizes. FIG. 3 shows a single pixel module 36 in greater detail. The pixel module 36 includes a number of LEDs 38 which collectively light up when the pixel module is activated. The LEDs 38 are housed within a shroud 40, which prevents leakage of light between adjacent pixel modules. Using techniques known in the art, the pixel modules 36 can each be selectively activated in order to collectively display a message visible to viewers located in front of the sign 10. Although LED based pixel modules are described in the current embodiment, other pixel modules could alternatively be used, for example, modules that use light sources other than LEDs (for example laser, incandescent or fluorescent light sources) or modules that use indirect lighting arrangements such as flip-dot pixels. Accordingly, broader aspects of the invention are not to be limited to LED pixel modules.

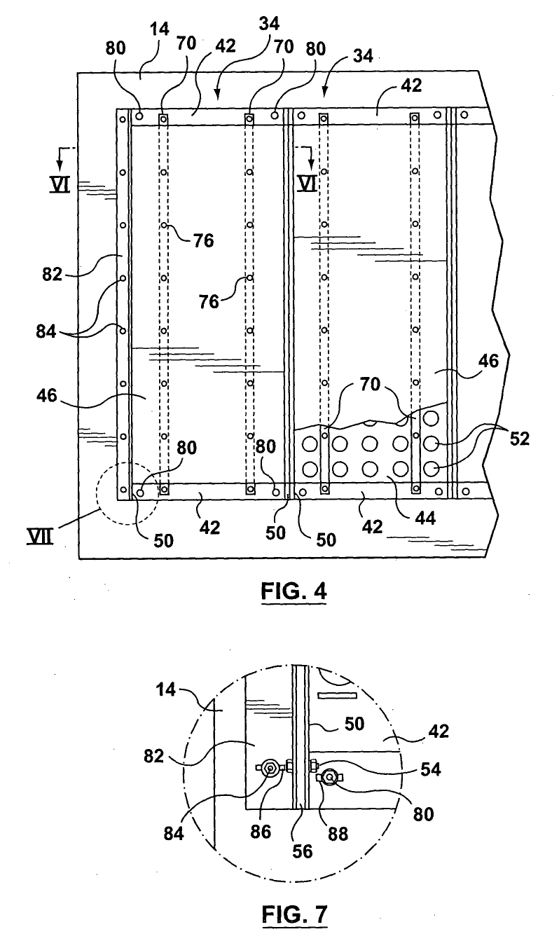

With reference to FIGS. 4, 5 and 6, the configuration of modular display panels 34 will now be explained in greater detail. FIG. 4 shows, from the inside of enclosure 12 the back side of two display panels 34, which are secured to the front wall 14 of the enclosure. With references to FIGS. 4, 5 and 6, each modular display panel 34 includes a rigid outer front panel 42, a sheet lens 44, and a rigid printed circuit board 46 on which are supported the pixel modules 36. The front panels 42 are elongated structures that are preferably each formed from a unitary metal sheet and have a truncated-U shaped cross section. A portion of one of the circuit boards 46 is cut away in FIG. 4 to show a back side of the sheet lens 44 and front panel 42. The front panel 42 has a substantially planar central portion 48 with integral rearwardly extending peripheral side walls 50 along opposite elongate side edges thereof. As will be explained in greater detail below, adjacent modular display panels 34 are secured together by clamping together adjacent side walls 50 of the front panels 42 of the display panels, with the central planar portions of the front panels arranged in a common plane. An array of aperture holes 52 are provided through the planar central portion 48 of each front panel. In the illustrated embodiment, the aperture holes are circular; however other configurations could alternatively be used in some embodiments. In a preferred embodiment, a row of horizontal slots 90 are provided through the front panels 48 underneath the bottom row of aperture holes 52 to permit any water that gets between the front panel 42 and the sheet lens 44 to drain out.

In each display panel, the sheet lens 44 is secured rearwardly of the central portion 48 of the front panel 42 and extends over the aperture holes 52. The sheet lens 44 is preferably a planar polycarbonate sheet through which light can pass, such as a Lexan (trade-mark) sheet. Preferably, a single sheet of Lexan is used for the sheet lens in each display panel 34. The sheet lens 44 is preferably nested between the sidewalls 50 of the front panel 42.

The rigid printed circuit board 46 of a display panel is secured rearward of the sheet lens 44, between the sidewalls of the front panel 42. Pixel modules 36 are supported by the circuit board 46 in alignment with the aperture holes 52 so that, when activated, the visual signals generated by the pixel modules 36 can be seen from a front of the sign 10.

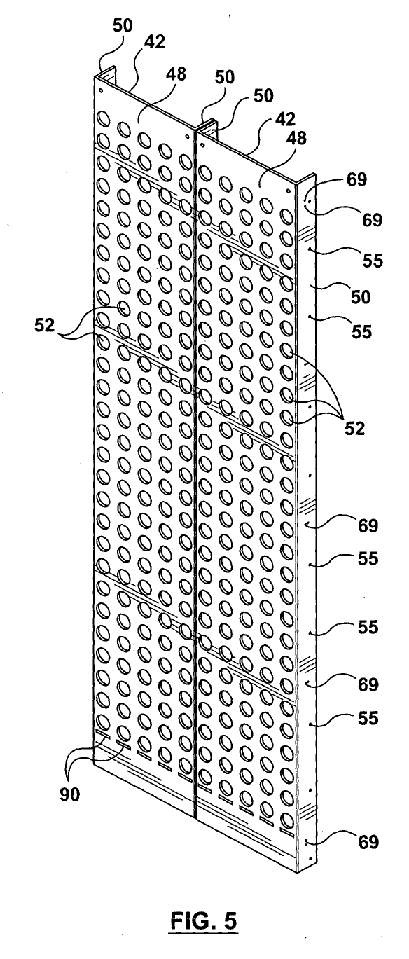

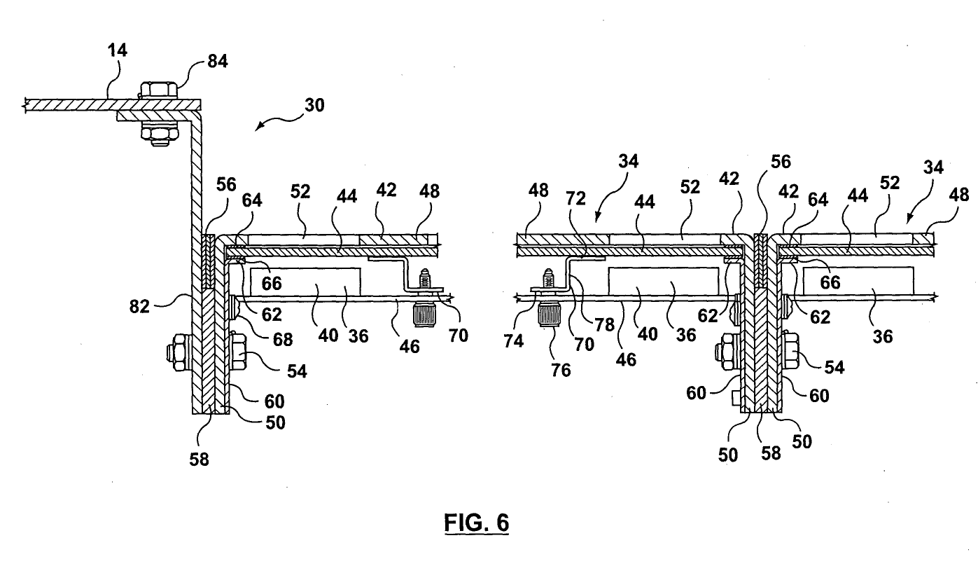

As best seen in FIG. 6, the side walls 50 of adjacent front panels 42 are arranged adjacent to each other and clamped together by a series of inter-panel bolts 54 which extend through holes provided along the length of the adjacent side walls 50. In particular, an elongate L-shaped bracket 60 is provided along the length of the inner side of each side wall 50, and the inter-panel bolts 54 extend through aligned openings 55 (see FIG. 5) provided through the side walls 50 and the L-brackets 60 of adjacent front panels 42. In addition to adding structural strength to the joined side walls, each of the L-brackets 60 has a planar front flange 62 that is perpendicular to the rest of the L-bracket body 60. The front flange 62 is arranged opposite the central portion 48 of the front panel 42 to secure the sheet lens 44 in place. In particular, the sheet lens 44 is secured along both of its longitudinal edges by a clamping force provided by the front flanges 62 of brackets 60 and the central portion 48 of the front panel 42.

An inter-panel resilient water impervious gasket 56 is squeezed between the side walls 50, by inter-panel bolts 54, along the length of the joint between adjacent panels 42 in order to provide a weather tight seal to impede outside elements from entering the enclosure. An elongate metal spacer 58 may also be provided between the adjacent side walls 50, behind the gasket 56. The spacer 58 is calibrated so that a desired degree of compression is provided to the gasket 56. During assembly, screws 68, which pass through holes 69 in the sidewall 50 (FIG. 5), may be used to secure the L-Bracket 60 to its corresponding sidewall and spacer 58.

As best seen in FIG. 6, a resilient gasket 64 is also provided as the contact interface between the central portion 48 of the front panel 42 and the sheet lens 44. The gasket 64 serves a dual purpose of providing a sealant along the elongate edges of the sheet lens 44 and the front panel central portion 48 in order to protect against outside elements entering the enclosure, and also to act as a spacer so that the front surface of the sheet lens 44 is set back or spaced from the back surface of the central portion 48. Such spacing permits water to enter through aperture holes 52 into a narrow area between the central portion 48 and the sheet 44, run down along the sheet 44, subsequently exit through drainage holes 90 (see FIG. 5) provided near the bottom of the display panel. Dynamic messaging signs are frequently used in high traffic locations where build-up of grime and dirt on the face of the sign are a common problem. The present configuration allows natural rain water to reduce the build-up of contaminants on the sheet lens 44, and also facilitates scheduled cleanings. In the illustrated embodiment, resilient back gaskets 66 are also provided between the L-brackets 60 and the sheet lens 44 to further prevent water from entering the inside of the enclosure.

The circuit board 46 of each display panel is secured such that a forward surface of the circuit board 46 is spaced back from the back surface of the sheet lens 44. In order to secure the circuit board 46, maintain correct spacing between the sheet lens 44 and the circuit board 46 and add structural strength, in one preferred embodiment, a pair of intermediate support bars 70 extend the length of each display panel 34, between the circuit board 46 and the sheet lens 44. With reference to FIG. 4, the support bars 70 are secured by bolts or other fastening means at their respective top and bottom ends to the front panel 42. With reference to FIG. 6, the elongate portion of the support bar 70 which passes between the sheet lens 44 and the circuit board 46 has a generally “Z” shaped cross-section, with a front planar member 72 secured by adhesive along its length to a back surface of the sheet lens 44, and a back planar member 74 to which the circuit board 46 is secured by bolts 76. The front and back member 72, 74 are joined by a perpendicular intermediate member 78. The front planar member 72 and back planar member 74 extend in opposite directions from the opposite side-edges of the intermediate member 78.

In the illustrated embodiment, the shrouds 40 that surround each of the pixel display modules 36 each have a forward end which is set back from the rear side of the sheet lens 44. The enclosure 12 will typically house an electronic controller to which all the pixel display modules are electrically connected such that desired dynamic messages can be displayed in dot matrix fashion on the sign 10. The circuit board 46 associated with each modular display panel 34 may be broken up along its length into a number of smaller circuit board sections.

In order to secure the sides of the two end modular display panels 34 to the front wall 14 of the enclosure, elongate L-brackets 82 (see FIGS. 4 and 6) are secured to the front wall 14 along the sides of the large opening 30. As best seen in FIG. 4, a series of bolts 84 or other fastening devices can be used to secure the L-brackets 82 along the vertical sides of the opening 30 in front wall 14. As best seen in FIG. 6, bolts 54 are used to secure the outer side wall 50 of an end display panel 34 to the L-bracket 82. Preferably, an elongate gasket 56 is provided between the opposing faces of the L-bracket 82 and the side wall 50 in order to seal the joint therebetween against external elements. A spacer member 58 may also be located between the outer wall 50 and the L-bracket 82. Thus, the juncture between the L-bracket 82 and the side wall 50 is similar to the inter panel clamping that occurs between the side walls 50 of adjacent front panels 42. The tops and bottoms of the modular display panels 34 are each secured, in the illustrated embodiment, to the front wall 14 of the enclosure by bolts 80, which pass through the front panel 42 into the supports 28 for the front wall 14. As can be seen in FIG. 2, in the illustrated embodiment, the display unit 32 is set in from an outer surface of the front wall 14, with the front wall and display unit being angled slightly downwards to facilitate viewing when the sign is mounted in an overhead position. A waterproof gasket 92 is provided along the top joint between front wall support members 28 and the front panels 42 to resist against external elements entering the enclosure.

FIG. 7 shows the mounting of L-bracket 82 to the front wall 14 and side wall 50 of panel 42 in greater detail, being an enlargement of the portion of FIG. 4 indicated by call out numeral VII. As shown in FIG. 7, in one preferred embodiment, horizontal slots 86 are provided through the L-bracket 82 for receiving the bolts 84 that secure the L-bracket 82 to the front wall 14 of the enclosure. Such a configuration provides some horizontal adjustment when assembling the sign. Similarly, horizontal slots 88 may be provided though front panels 42 for receiving the bolts 80 that secure the front panels to the front wall 14. Such a configuration assists in allowing the display unit 32 to be properly centered within the front wall opening 32 during installation and removal.

The front panels 42 are generally painted black on at least their outer surface, and pixel modules 36 are also typically black when not activated. In some embodiments, the sheet lens 44 in each modular display panel 34 may be omitted and replaced with individual lenses which are secured to the shroud 40 of each pixel display module 36.

As noted above, in the illustrated embodiment, each modular display panel 34 comprises a 5 by 28 array of pixel display modules 36. In an example embodiment, the aperture holes 52 are uniformly spaced. The openings located closest to the side walls of the panels are spaced from the sides a distance such that the uniform spacing between aperture holes is maintained between adjacent panels. It will be appreciated that such dimensions are exemplary and a number of different other configurations could alternatively be used. Although the elongate display panels 34 are shown vertically arranged in the Figures, in alternative embodiments, the panels may have different orientations.

In the present invention, the modular display panels 34 can be individually removed and replaced from the inside of the enclosure. The interconnected U-shaped front panels 42 of the display panels 34 provide a lightweight support structure for the display unit 32, and protect the sheet lenses 44 that are located behind them.

With reference to FIG. 2, in some embodiments of the invention, one or more blower units 94 could be located at the bottom of the enclosure 12 under the floor 26. The blower units 94 are arranged to take in air through an intake vent 96, and then blow the air up into the space provided between the sheet lens 44 and the circuit board 46 of each of the display panels, as indicated by arrows 96. The blower units are housed within shrouds in the enclosure 12 such that the air output by the blower units is directed up into the space between the sheet lens 44 and the circuit board 46. In warmer climates, the air flow over the circuit board can cool the board. In cooler climates, one or more heating elements 98 may be provided for heating the air output by the blower units 94, for the purpose of reducing condensation on the sheet lens and on the circuit board.

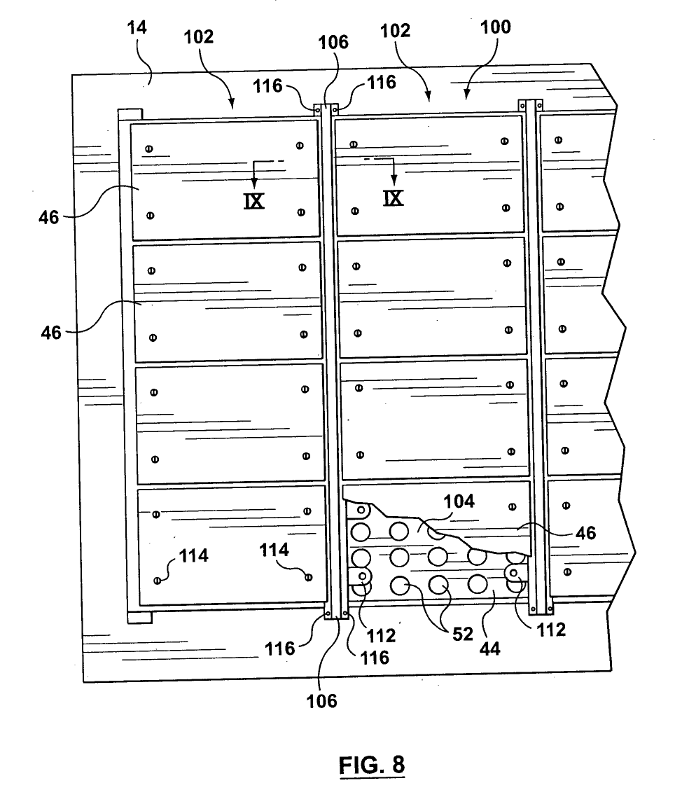

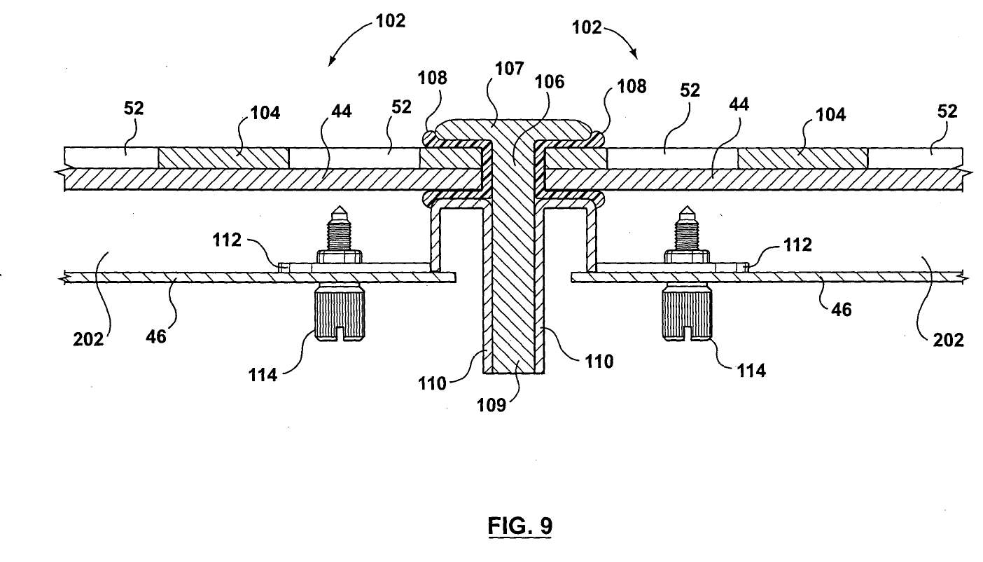

Referring now to FIGS. 8 to 11, a further embodiment of an informational display unit, indicated generally by 100, is shown. The informational display unit 100 can be mounted instead of informational display unit 32 in the large rectangular opening 30 that is provided through the front wall 14 of enclosure 12 of the sign 10, and from a front viewing side (such as shown in FIG. 1) informational display unit 100 appears substantially similar to informational display unit 32. Informational display unit 100 is made up of vertically elongated abutting modular display panels 102. In order to support the display panels 102, a plurality of vertically extending T-shaped columns 106 are secured at uniformly spaced intervals across the rectangular opening 30 at the front of the sign. The columns 106 are secured by bolts 116 or by welding at their top and bottom ends to horizontal support bars that are secured to the front wall 14. Each display panel 102 includes a vertically elongated planar front panel 104 through which apertures 52 are formed. The sheet lens 44 is secured behind the front panel 104, and circuit boards 46 are located behind and spaced apart from the sheet lens with an air gap 202 being located there between. Elongate J-shaped mounting brackets 110 are used to secure the sheet lens 44 and front panel 104 against the elongated front portion 107 of the T-column 106. The mounting bracket 110 is preferably secured with screws or bolts (not shown) to the rearward portion 109 of T-column 106 that extends rearwardly between the adjacent front panels 104. As can be appreciated from FIG. 9, the T-column 106 and J-bracket 110 cooperate to clamp the sheet lens 44 and front panel 104 of each display panel together, the front surface of the adjacent front panels 104 each being engaged by the front portion 107 of the T-column, and the rear surface of each sheet lens 44 being engaged along its edge by a respective J-bracket. In an example embodiment, U-shaped gaskets 108 surround the edge areas of panels 104 and sheet lens 44 to provide a water impervious seal around the edges of the display panels 102. In various embodiments, U-shaped gasket 108 is replaced with separate flat gaskets located a) in front of the panel 104 and behind the sheet lens 44; b) in front of panel 104 and between the panel 104 and the sheet lens 44, or c) in front of the panel 104 and behind the sheet lens 44, and between the panel 104 and the sheet lens 44. Spaced apart flanges 112 are provided along the length of each bracket 110 to permit circuit boards 46 to be secured thereto by bolts 114.

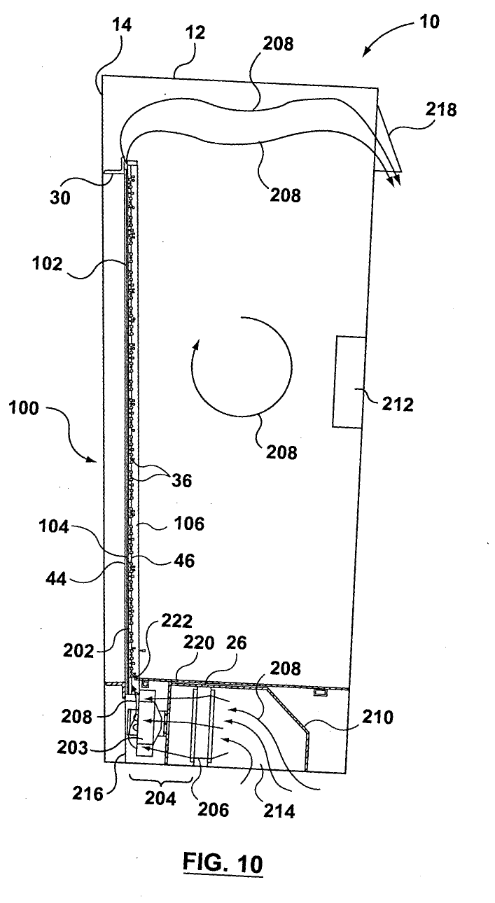

With reference to FIGS. 10 and 11, a further climate control system that can be applied, in various embodiments, to messaging signs 10 having display units 100 or 32 will now be described. The system shown in FIGS. 10 and 11 includes fans 203 that are mounted horizontally inside fan boxes 210 provided under the floor 26 of the enclosure. Each display panel 102, or in some embodiments, groups of display panels 102, has or have an associated fan 203 for forcing air up into the gap 202 between circuit boards 46 and the sheet lens 44. Each fan box 210 includes a relatively narrow air channel 204 in which the fan 203 is mounted with an exhaust side directed towards a front wall 216 of the air channel 204. The air channel 204 communicates with the air gap 202. As indicated by representative air flow lines 208, air enters the fan box 210 through an inlet 214, and passes through filter 206 into air channel 204. After passing through fan 203, the air is forced into gap 202 at the bottom of the associated display panel 102. The air passes through gap 202, then exits into the enclosure 12 at the top of the display panel 102. An exhaust vent 218 provided on an upper section of a back wall of the enclosure 12 allows air to escape from the enclosure 12.

A further fan unit 212 is located on the back wall of the enclosure 12 for circulating air within the enclosure 12 behind the circuit boards 46. In an example embodiment, bolted or otherwise secured panels 220 are located above the air channels 204. A resilient gasket 222 is provided at a forward end of each access panel 220 to provide a seal at the top of the air channel 204 such that air leaving the air channel 204 is directed into gap 202 and not otherwise lost. Such an air circulating system permits a relatively high static air pressure build up in the air channels 204, resulting in a relatively high air flow through the associated air gaps 202. In some embodiments, a heating unit is placed adjacent to fan 203 to permit heated air to be directed into air gaps 202 in cold weather applications.

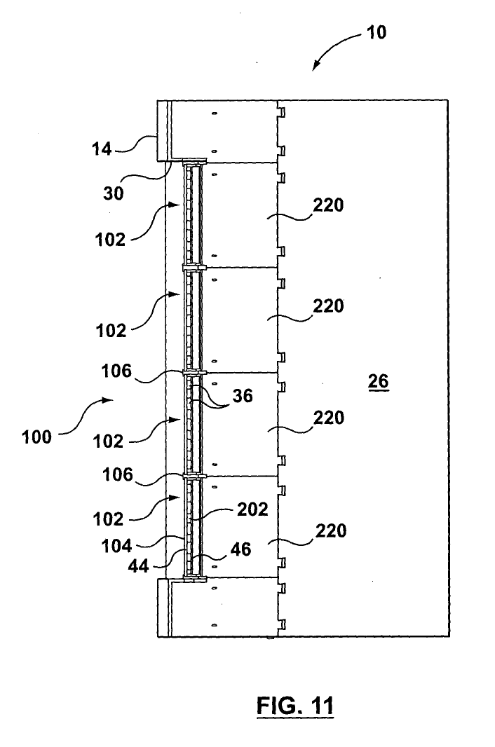

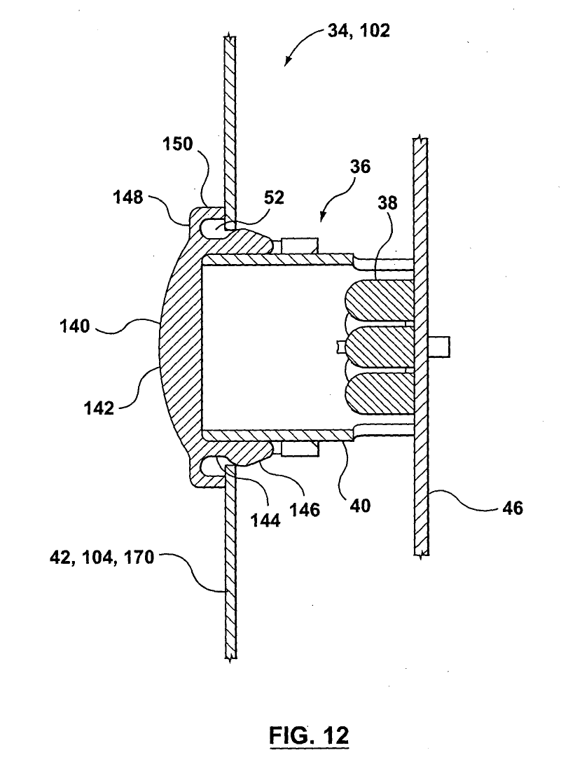

As suggested above, in some embodiments of the invention, individual lenses may be used for each pixel module 36 in the place of sheet lens 44. In this regard, FIG. 12 shows a partial sectional view of embodiments of display panel 34, 102 in which lens sheet 44 is omitted, and individual lens caps 140 are used for each of the pixel modules 36. In the illustrated embodiment, a forward end of the cylindrical shroud 40 protrudes through the aperture 52 on the front panel 42,104. The lens cap 140 includes a circular transparent or translucent lens portion 142 through which light from LEDs 38 can be observed. Lens portion may be a convex or other shaped lens to provide a desired light distribution. An annular wall 144 is provided around a peripheral edge of the lens portion 142. The annular wall 144 is sized so that it can be inserted through aperture 52 and snuggly fit over and frictionally engage the forward end of shroud 40. The annular wall 144 may have an enlarged back end portion 146 with an outer circumference larger than the circumference of aperture 52 for engaging the front panel 42,104 about the aperture 52 to resist removal of the lens cap 140 once it has been mounted on shroud 40. The front panel 42, 104 and or the annular wall 144 are sufficiently resilient to allow enlarged end 146 to pass through aperture 52 for snap-fitting of the lens cap 140 onto the pixel module 36. An annular flange 148 having an L-shaped cross-section is also provided about the peripheral edge of the lens portion 142. The annular flange 148 has an outer flange portion that is spaced apart from wall 144 has an end that bears against the front surface of panel 42,144, thereby limiting the distance that the lens cap 140 can be pushed into the aperture 52.

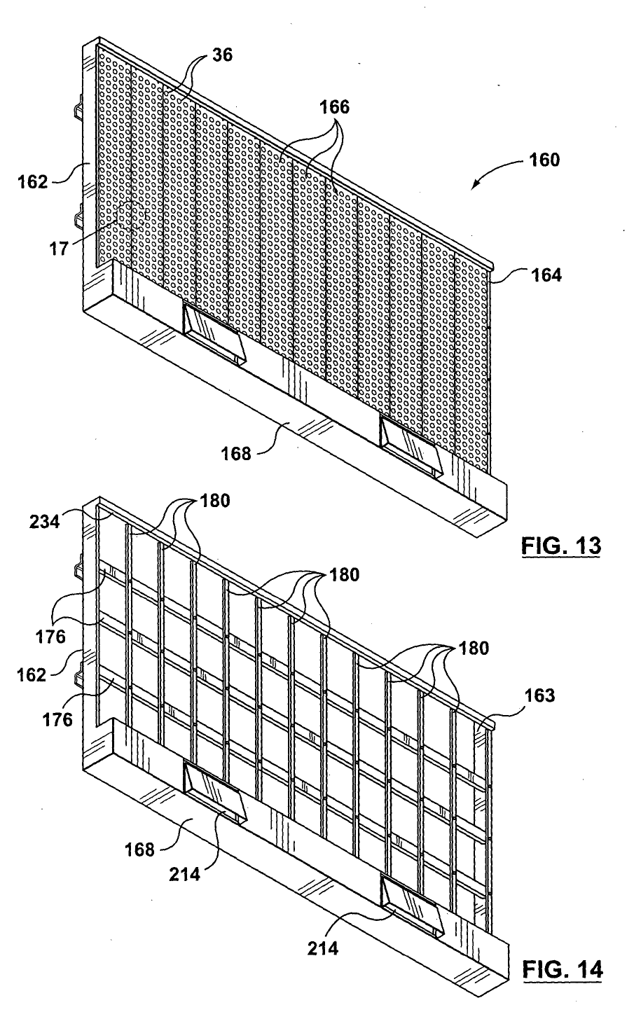

Another messaging sign, indicated generally by reference 160, is shown in FIG. 13 according to various embodiments of the invention. Messaging sign 160 is configured to permit front access to the display panels, rather than internal access. In this regard, the messaging sign 160 includes a enclosure 162 to which is mounted an informational display unit 164 that is made up of a number of vertically elongated adjacent display panels 166, including a pair of end display panels separated by a plurality of intermediate display panels. As with messaging sign 10, each display panel 166 includes a uniform array of pixel modules 36. Enclosure 162 may have enlarged accessories box 168 for housing ventilation and heating fans, controllers, power supplies, and other accessories typically associated with the messaging sign. Although the box 168 is shown at the bottom of the display unit 164, the box 168 (or additional boxes) could alternatively be located elsewhere, such as above or to the sides of the display unit 164.

FIG. 14 shows the enclosure 162 of sign 160 without display panels 166. Enclosure 162 defines a large front opening 163 in which the display panels 166 are mounted. A number of spaced apart vertically extending C-channel supports 180 are provided across the opening 163 for supporting the display panels 166, along with a number of spaced apart horizontally extending Z-bar supports 176.

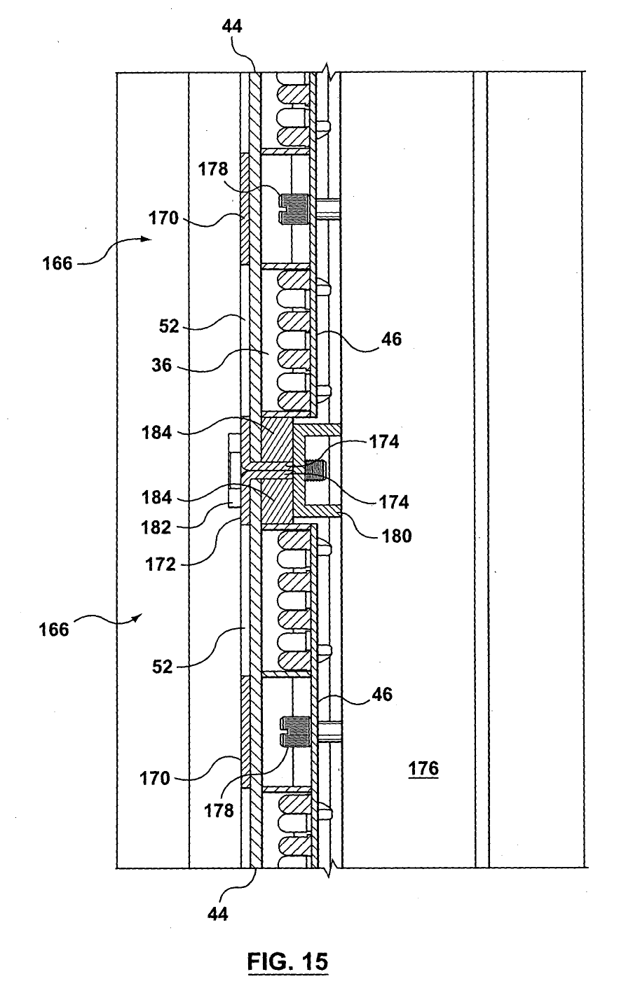

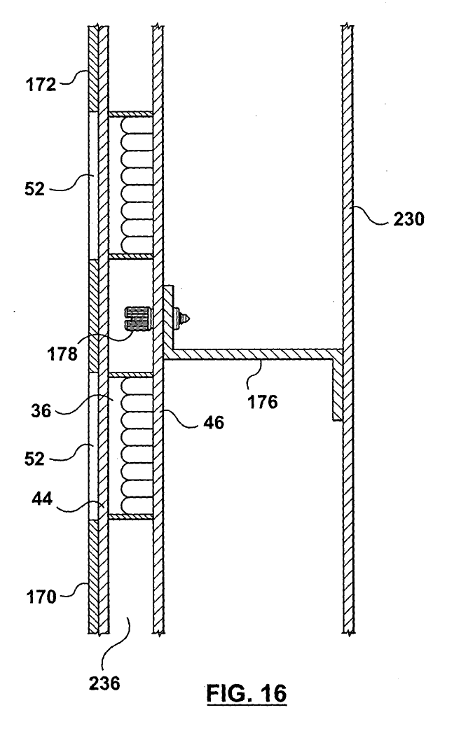

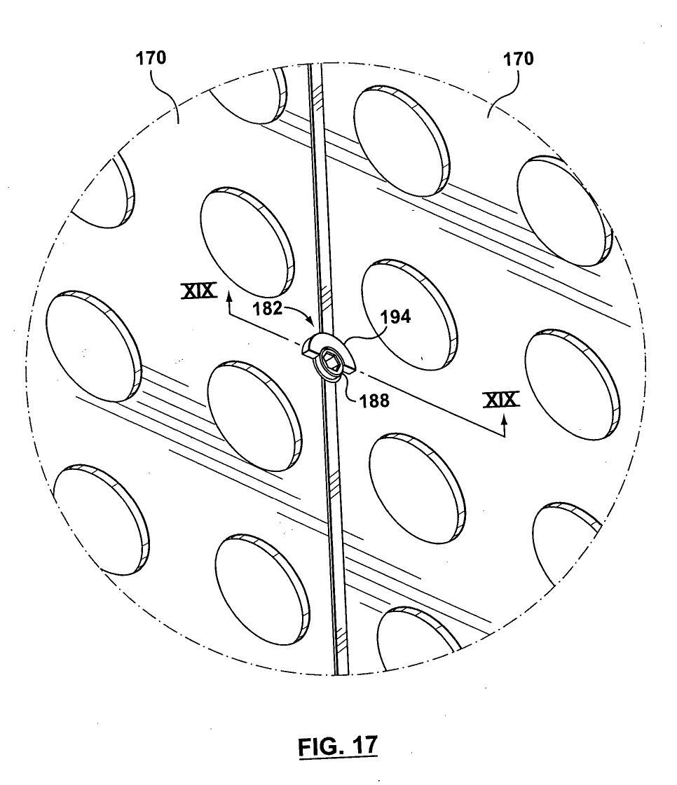

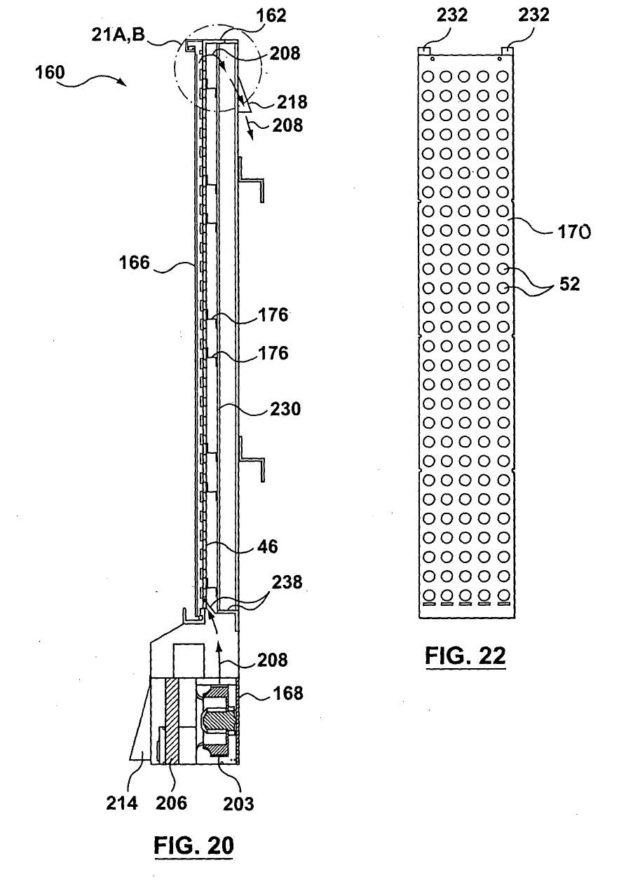

With reference to FIGS. 15,16,17, and 20, the configuration of display panels 166 will be described in greater detail. FIG. 15 shows a partial horizontal sectional view of two adjacent display panels 166, FIG. 16 is a partial vertical sectional view of one of display panels 166, and FIG. 17 an enlarged partial front perspective view of two display panels 166. FIG. 20 shows a sectional side view of sign 160. Each display panel includes a rigid outer front panel 170, a sheet lens 44, and a rigid printed circuit board 46 supporting pixel modules 36. Similar to the front panels 42 of sign 10, front panels 170 are each formed from a unitary metal sheet and have a truncated U-shaped horizontal cross-section. As best seen in FIG. 15, each front panel 170 includes a substantially planar central portion 172 with integral rearwardly extending peripheral side walls 174 along opposite vertically extending side edges thereof. As with sign 10, the front panels 170 of adjacent modular display panels 166 are secured to the enclosure 162, with the central planar portions 172 arranged in a common plane. Aperture holes 52 are provided through the planar central portion 170 of each front panel 170, each aperture hole 52 being aligned with an associated pixel module.

In each display panel, the sheet lens 44 is secured rearwardly of the central portion 172 and extends over the aperture holes 52, and the circuit board 46 is secured rearwardly of the sheet lens. As best seen in FIGS. 14, 15,16 and 20, one or more horizontal support “Z” bars 176 are mounted within and supported by the enclosure 162. In various embodiments, the support bars 176 are supported by further vertical supports 230 secured within the enclosure 162. The circuit boards 46 of each of the display panels 166 are secured to the horizontal support bars 176 by bolts 178.

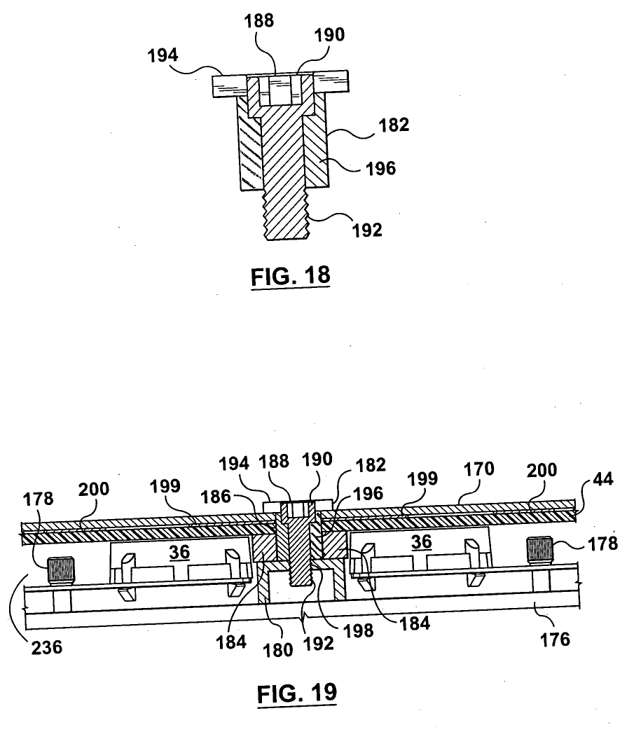

The vertical C-channel support bars 180 are secured to the enclosure 162 at spaced intervals across the front opening of the enclosure forwardly of horizontal bars 176 for supporting the front panels 170 and sheet lenses 44. In an example embodiment, the rearward edges of pairs of adjacent sidewalls 174 engage a forward surface of a corresponding support bar 180. Vertical resilient gaskets 184 are provided between the back surface of sheet lens 44 and the forward surface of support bar 180 to sealably retain the sheet lens 44 in place. Clamps 182 are used in combination with the gaskets 184 to secure the front panels to each other and vertical support bars 180. A number of clamps 182 are located along each of the junctures between the abutting side walls 174 of adjacent front panels 170. As best seen in FIGS. 17-19, each clamp 182 includes a bolt 188 having an enlarged head 190 and threaded shaft 192. The shaft 192 passes through grooves 186 that are provided in the side walls 174 of the front panels 170, and into a threaded opening 198 provided through the vertical support bar 180. The shaft can be tightened into the support bar 180. A semi-circular shaped swivel head 194 is rotatably mounted on the shaft 192 to apply clamping force to the outer surface of adjacent front panels 172. The swivel head 194 is movable between three positions. In the position shown in FIG. 17, the head 194 engages the front surface of two adjacent front panels 170, thereby applying a clamping force to both panels. In the further two positions, the head 194 can be selectively rotated to only apply clamping force to a selected one of the two front panels 170, thereby allowing the non-clamped front panel 170 and associated sheet lens to be removed for maintenance or replacement purposes. As best seen in FIGS. 18 and 19, the head 194 is mounted on a tubular member 196 that surrounds shaft 192. In one embodiment, a flat washer-like gasket 199 surrounds the circumferences of tubular member 196 in an area between the panel 170 and sheet lens 44, providing a seal against outside elements entering between the panel and lens from the clamp area. In an example embodiment, strips of adhesive tape 200 or other adhesive are provided between the sheet lens 44 and the front panel 170 to secure the two components relative to each other.

Various aspects of messaging sign 160 according to embodiments of the invention will now be explained with reference to FIGS. 20-22. In an example embodiment, a pair of J shaped connectors 232 are provided along a top edge of front panel 170. The connectors 232 cooperate with a J-shaped ledge 234 (see also FIG. 14) that extends the length of the enclosure 162 along the upper side of the front opening through enclosure 162. The J-shaped connectors 232 extend towards the front, viewing side, of the sign, and each define a downward opening channel, and the J-shaped ledge 234 extends into the enclosure 162, towards the back of the sign, defining a cooperating upward opening channel. Such a configuration permits the front panels 170 (and adhesive-attached sheet lens 44) to be supported by ledge 234 and slid along ledge 234 when mounting the front panels 170 to the enclosure 162 and to access pixel modules 36 for maintenance purposes.

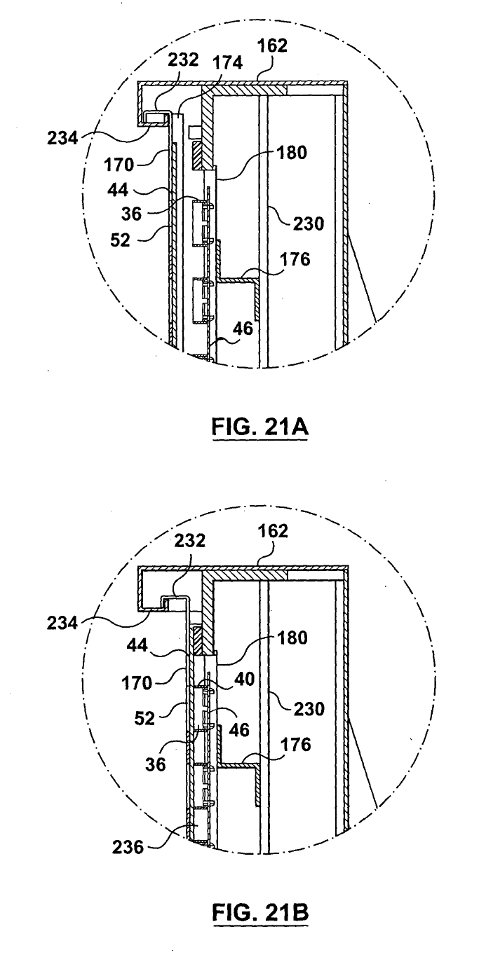

FIGS. 20 and 21A show the front panel 170 (and associated sheet lens 44) of a display panel 166 in a “sliding” position, in which clamps 182 that normally secure the panel and sheet lens have been released. In the sliding position, the front panel 170 is moved towards the front of the sign 160, such that it is spaced forward of circuit board 46 and pixel modules 36. In such position, the front panel 170 is supported by ledge 234 and can be slid sideways along ledge 234 to permit full frontal access to the pixel modules 36 and circuit boards 36 normally located behind the front panel 170 (and associated sheet lens 44). The forward movement permitted by cooperating ledge 234 and J-connectors 232 is sufficient to allow the front panel 170 (and integral sidewalls 174) and associated sheet lens 44 to be moved far enough forward that they can subsequently be slid sideways in front of the front panel 170 of an adjacent display panel 166. FIG. 21B shows the front panel in a “secured” position in which it is slid into its normal position and secured in place by clamps 182.

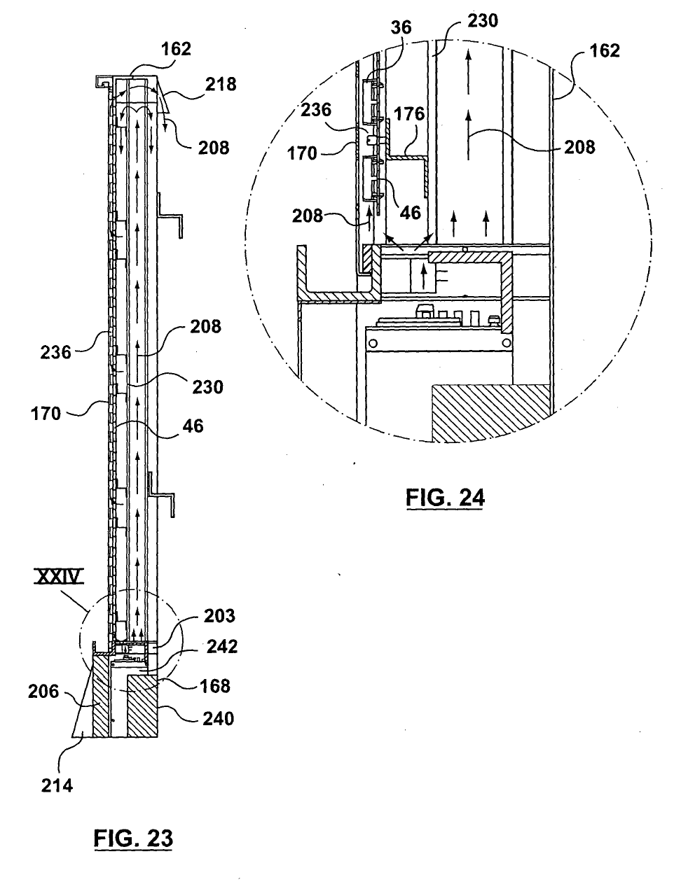

An air gap 236 is provided between circuit board 46 and the back of sheet lens 44 when the front panel is in the normal secured position. As with the messaging sign 10 described above, a climate control system is also provided in embodiments of messaging sign 160. As best seen in FIG. 20, in an example embodiment, a one or more horizontally arranged blower or fan units 203 are located in compartments provided in the accessories box 168 of enclosure 162. The fan units 203 draw air into the accessories box 168 through shrouded air intake vents 214 and filters 206, and force the air up into air gaps 236 of display panels 166, as shown by air flow lines 208. The air exits air gaps 236 through the upper ends of the display panels 166. Exhaust vents 218 are provided on the back of the enclosure 162 for air to escape the enclosure. In one embodiment, dividing walls 238 are provided between the fan compartments in accessories box 168 and the rest of the enclosure 162 to ensure that air from the fans is forced up into the air gaps 236, rather than generally into the enclosure 162. Although fan 203 is horizontally arranged, other fan orientations such as vertically arranged can alternatively be used. In this regard, FIGS. 23 and 24 show a further ventilation arrangement according to embodiments of the invention. In such configuration, a vertically oriented fan 203 is located next to a controller 242 and power supply 240 in accessories box 168. The fan 203 draws in air through air intake 214 and filter 206, and forces it up into enclosure 162. In the embodiment of FIGS. 23 and 24, the enclosure 162 is not fully closed off from the fan compartment, thus air flows upward in parallel both through enclosure 162 and through the gap 236, on both the front and back sides of circuit boards 46. Air can pass from the enclosure behind the circuit boards 46 into air gaps 236 and vice versa through spaced provided between adjacent circuit boards 46.

Individual lenses 142 are, in various embodiments of sign 160, used in place of a sheet lens 44. In an example embodiment, the spacing between aperture holes 52 is uniform across the sign 160.

As will be apparent to those skilled in the art in light of the foregoing disclosure, many alterations and modifications are possible in the practice of this invention without departing from the claimed scope thereof. Accordingly, the scope of the invention is to be construed in accordance with the substance defined by the following claims.

What is claimed is:

1. An informational display unit for a dynamic messaging sign, having at least two display panels that are arranged adjacent each other, each display panel including (i) a rigid front panel having a planar central portion with an array of aperture holes formed therethrough, (ii) a planar sheet lens through which light can pass secured behind the planar central portion, the sheet lens passing over the aperture holes, and (iii) a plurality of pixel display modules located behind the sheet lens, each pixel display module being aligned with one of the aperture holes for selectively displaying an indicator visible from a front of the display panels; the rigid front panels being joined along adjacent sides thereof and arranged with the front panel planar central portions substantially aligned in a common plane.

2. The display unit of claim 1 including an elongate support column having a front portion engaging a front surface of each of the rigid front panels, and a rearward portion extending rearwardly of the front portion between the adjacent sides of the front panels.

3. The display unit of claim 2 wherein, for each display panel, a front surface of the sheet lens engages a back surface of the front panel, and including clamp means secured to the support column for engaging a back surface of the sheet lens of each display panel.

4. The display panel of claim 3 wherein for each display panel, the pixel display modules are mounted on at least one rigid circuit board that is mounted to the clamp means.

5. The display panel of claim 2, wherein the support column has a T-shaped cross-section.

6. The display unit of claim 1 wherein the sheet lens and pixel display modules of each display panel are supported by the front panel thereof.

7. The display unit of claim 1 wherein the rigid front panel of each display panel includes a pair of integral rearwardly projecting sidewalls along opposite side edges of the planer central portion, the display panels having adjacent sidewalls that are secured together.

8. A dynamic messaging sign comprising:
(a) an enclosure having a forward facing opening; and
(b) a plurality of display panels arranged side by side across the forward facing opening, each of the display panels including:
(i) a rigid front panel having a substantially planar central portion with integral rearwardly extending peripheral sidewalls along opposite side edges thereof, the central portion having an array of aperture holes formed therethrough; and
(ii) a plurality of pixel modules arranged rearward of the front panel in alignment with the aperture holes for selectively generating indicators visible though the aperture holes;
the planar central portions being substantially aligned along a common plane with adjacent front panel sidewalls of adjacent display panels being secured together.

9. The sign of claim 8 wherein each of the display panels include a sheet lens through which light can pass, the sheet lens being located between the planar central portion of the front panel and the pixel modules and extending over the aperture holes.

10. The sign of claim 9 wherein for each of the display panels a front surface of the sheet lens is spaced apart from a back surface of the planar central portion.

11. The sign of claim 10 wherein drain openings are provided in a lower portion of the central portion of the rigid panels for draining water from between the sheet lenses and the planar central portions.

12. The sign of claim 9 wherein for each of the display panels, the sheet lens and the pixel modules are supported by the front panel.

13. The sign of claim 9 wherein each of the display panels includes a bracket on each sidewall, edge portions of the sheet lens being clamped between the sidewall brackets and the front panel central portion.

14. The sign of claim 13 where the sidewall brackets extend substantially the entire length of the sidewalls and a water impervious gasket is provided between the clamped edge portions of the sheet lens and the front panel central portion.

15. The sign of claim 9 wherein each display panel includes at least one rigid printed circuit board to which the pixel modules are mounted, the circuit board being spaced rearward of the sheet lens.

16. The sign of claim 15 wherein each display panel includes at least one support member extending between the printed circuit board and the sheet lens, the support member having a first elongate planar member abutting the sheet lens and a second elongate planar member abutting the printed circuit board, the first and second planar members being joined by an elongate intermediate member.

17. The sign of claim 15 wherein the sign includes at least one blower unit arranged to blow air through spaces between the circuit boards and the sheet lenses of the display panels.

18. The sign of claim 8 wherein a water impervious gasket is located between the adjacent sidewalls.

19. The sign of claim 8 wherein the front panels are secured to the enclosure by bolts passing through slots provided through at least one of the enclosure or the front panels, the slots having a horizontal width greater than the bolts such that the horizontal positioning of the bolts in slots can be adjusted.

20. The sign of claim 8 wherein each display panel includes at least one rigid printed circuit board to which the pixel modules are mounted, the circuit board being spaced rearward of the central planar portion, each pixel module having a forwardly extending shroud on which is mounted a lens cap having a lens section through which light from the pixel module can pass.

21. The sign of claim 8 including a plurality of spaced apart support members extending across the forward facing opening and secured to the enclosure, and a plurality of clamps clamping the front panels to the spaced apart support members, at least some of the clamps having a front portion for simultaneously engaging the front panels of a pair of adjacent display panels and a rearward portion for engaging one of the support members.

22. The sign of claim 21 wherein each display panel includes a planar sheet lens through which light can pass, the sheet lens being located between the planar central portion of the front panel and the pixel modules and extending over the aperture holes.

23. The sign of claim 22 wherein the sheet lens is secured to the front panel by adhesive.

24. The sign of claim 22 wherein for at least some of the display panels, a forward surface of the sheet lens engages a rearward surface of the planar central portion of the front panel, the sheet lens having elongate side edge portions adjacent the sidewalls of the front panel with elongate resilient gaskets being clamped rearward of the elongate side edge portions.

25. The sign of claim 21 wherein, for the at least some of the clamps, the front portions of the clamps are movable between a position in which the front portion engages simultaneously the front panels of the pair of adjacent display panels, a second position in which the front portion engages a first one but not a second one of the adjacent front panels, and a third position in which the front portion engages the second one but not the first one of the adjacent front panels.

26. The sign of claim 21 including rigid circuit boards to which the pixel modules are mounted, the circuit boards being spaced rearward of the central planar portions of the rigid front panels, defining air gaps there between, the circuit boards being mounted to the enclosure independently of the front panels.

27. The sign of claim 26 wherein the enclosure includes an enlarged portion adjacent the forward facing opening, the enlarged portion housing a fan unit for directing air into the air gaps.

28. The sign of claim 26 wherein the enclosure includes a support member, each of the front panels including a connecting member slidably engaging the support member such that the front panel is slidable in a first direction away from the pixel modules located therebehind, and in a second direction along the support member lateral to the first direction to expose the pixel modules to access through the forward facing opening.

29. A dynamic messaging sign comprising:
(a) an enclosure having a forward facing opening;
(b) a plurality of spaced apart, substantially parallel, elongate support columns connected to the enclosure and extending across the forward facing opening;
(b) a plurality of display panels arranged side by side across the forward facing opening, each of the display panels including:
(i) a substantially planar rigid front panel having an array of aperture holes formed therethrough; and
(ii) a plurality of pixel modules arranged rearward of the front panel in alignment with the aperture holes for selectively generating indicators visible though the aperture holes,
the front panels being substantially aligned along a common plane, the support column being located between side-edges of the front panels of adjacent display panels.

30. The sign of claim 29 wherein each support column includes a front portion engaging a forward facing surface of each of the front panels that the support column is located between.

31. The sign of claim 30, each display panel further including a sheet lens through which light can pass, the sheet lens being located between the front panel and the pixel modules and extending over the aperture holes wherein, for each display panel, a front surface of the sheet lens engages a back surface of the front panel, and including clamp means secured to the support column for engaging a back surface of the sheet lens of each display panel.

32. The sign of claim 31 wherein for each display panel, the pixel display modules are mounted on at least one rigid circuit board that is mounted to the clamp means.

33. The sign of claim 30 wherein each display panel includes at least one rigid printed circuit board to which the pixel modules are mounted, the circuit board being spaced rearward of the front panel, each pixel module having a forwardly extending shroud on which is mounted a lens cap having a lens section through which light from the pixel module can pass.

34. The sign of claim 30, wherein the support column has a T-shaped cross-section.

35. A dynamic messaging sign comprising:
(a) an enclosure having a forward facing opening;
(b) a plurality of rigid front panels having an array of aperture holes therethrough, the front panels being arranged side-by-side across the forward facing opening;
(c) a plurality of circuit boards mounted to the enclosure rearward of the front panels, the circuit boards having pixel modules arranged thereon in alignment with the aperture holes for selectively generating indicators visible through the apertures from a viewing direction forward of the sign, the circuit boards being spaced apart from the front panels to define air gaps therebetween; and
(d) at least one fan located in the enclosure for directing air into the air gaps between the front panels and the circuit boards.

36. The messaging sign of claim 35 wherein the enclosure includes a compartment in which the fan is housed, the compartment having an outlet that is substantially exclusively in communication with the air gaps.
